(19) United States
(12) Patent Application Publication
(10) Pub. No.: US 2025/0208918 A1
(43) Pub. Date: Jun. 26, 2025

(54) BIOINFORMATICS PROCESSING ORCHESTRATION

(71) Applicant: Illumina, Inc., San Diego, CA (US)

(72) Inventors: Luan Truong, San Diego, CA (US); Nico Holguin, San Diego, CA (US); Bart Denotte, Puurs-Sint-Amands (BE); Isais Aguilar, Kennesaw, GA (US); Timothy Richardson, Canby, OR (US)

(73) Assignee: Illumina, Inc., San Diego, CA (US)

(21) Appl. No.: 18/392,404

(22) Filed: Dec. 21, 2023

(51) Int. Cl. G06F 9/50

(52) U.S. Cl. CPC G06F 9/5033

(57) ABSTRACT

Bioinformatics process orchestration includes receiving a request for bioinformatics processing in a bioinformatics pipeline implemented in a cloud computing environment with monitored availability zones (AZs), the bioinformatics processing including steps for deployment and execution in the bioinformatics pipeline, receiving a definition indicating options for respective resources of varying resource types to use in executing each step of the steps, and orchestrating the deployment and execution of the steps, which orchestrating includes selecting an AZ to perform the requested bioinformatics processing, and initiating execution of the steps by using the definition to select a resource, from indicated different resources of a given resource type, to use in executing the step, and initiating execution of that step. The orchestration also includes monitoring the execution of the steps in the selected AZ.

### BACKGROUND

Most cloud computing environments provide pooled and shared computing resources to various tenants for use. Cloud infrastructure is provided in physical locations referred to as ‘regions’, which typically correlate to a given geographic area. Each region provides availability zone(s), which are groups of data center(s) of the regions. The five well-known and essential characteristics of the cloud computing model are on-demand provisioning, network accessibility, resource pooling for multiple tenants, elasticity/scalability, and resource tracking and optimization. Uptime, resiliency, and access to resources that might otherwise be hard to achieve without a shared model are advantages provided by cloud environments.

### SUMMARY

Cloud environments have the illusion of being an infinite pool of resources with near infallible uptime. However, this illusion is dispelled when the resources requested approach the limits of availability.

Shortcomings of the prior art are overcome and additional advantages are provided through the provision of a computer-implemented method. The method receives a request for bioinformatics processing in a bioinformatics pipeline implemented in a cloud computing environment. The cloud computing environment includes a plurality of monitored availability zones (AZs), each with respective resources, and the bioinformatics processing includes a plurality of steps for deployment and execution in the bioinformatics pipeline. The method also receives, in conjunction with the request, a definition indicating options for respective resources of varying resource types to use in executing each step of the plurality of steps. The method additionally orchestrates the deployment and execution of the plurality of steps in the bioinformatics pipeline. The orchestrating includes selecting, from the plurality of monitored AZs, an availability zone (AZ) to perform the requested bioinformatics processing, then initiating execution of the plurality of steps in the selected AZ. The definition indicates, for a step of the plurality of steps and for a resource type to use in executing the step, a plurality of different resources, of that resource type, that are possible alternatives to each other for selection and use in executing the step. The initiating the execution includes using the definition to select a resource, from the indicated plurality of different resources, to use in executing the step, and initiating execution of the step with a direction to the selected AZ to use the selected resource. Additionally, the method monitors the execution of the plurality of steps in the selected AZ.

Additional aspects of the present disclosure are directed to systems and computer program products configured to perform the methods described above and herein. The present summary is not intended to illustrate each aspect of, every implementation of, and/or every embodiment of the present disclosure. Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example conceptual diagram of a processing pipeline and associated components within a cloud computing environment;

FIG. 2 depicts an example of a connected analytics environment employing multiple cloud compute regions;

FIG. 3 depicts an example of variation in regional capacity between two regions of a cloud environment;

FIG. 4 depicts an example of variation in capacity between different availability zones across regions of a cloud environment;

FIG. 5 depicts an example conceptual diagram of an atomic pipeline engine in accordance with aspects described herein;

FIG. 6 depicts an example orchestration of bioinformatics processing steps in accordance with aspects described herein;

FIG. 7 depicts an example process for bioinformatics processing orchestration, in accordance with aspects described herein;

FIG. 8 depicts an example process for monitoring execution of steps of requested bioinformatics processing, in accordance with aspects described herein; and

FIG. 9 depicts one example of a computer system and associated devices to incorporate and/or use aspects described herein.

### DETAILED DESCRIPTION

As noted, cloud environments do not have infinite resources, though often the assumption or expectation is that they do. When the amounts of resources requested approach the limits of availability, for instance when scaling sufficiently high, issues reveal themselves. First, the capacity of an availability zone (AZ) does not necessarily match that of other AZs. The capacity of a resource provided in a new availability zone might be a fraction of that of an established AZ, even when the AZs are in the same region, for instance. Similarly, the compute, storage, and other resource capacities of AZ(s) of a newly added region can differ from those of other, established regions. Furthermore, capacity is shared among all cloud users, and therefore available capacity of a given AZ is partly a function of the extent of consumption of that AZ by the other tenants. Consequently, it is not safe to assume that a workload that can be processed without issue by one AZ in one region would be similarly processed without issue by any other region or AZ. Spot errors and random errors also present themselves. For instance, the probability of random error increases as the size of a requested resource increases, and is cumulative of all the types of resources requested.

These and other factors subject resource-intensive bioinformatics pipelines to outsized reliability and costs risks. Bioinformatics pipelines, sometimes referred to as genomics analysis pipelines, refer to algorithms that process genomic sequencing data in steps to produce outputs. Genomic sequencing describes a method of identifying nucleotides or other component parts of genomic data. A nucleic acid sequencing device, also referred to as a sequencer, generates data as base calls, for instance ones corresponding to, or representing, nucleotides of a ribonucleic acid (RNA) or deoxyribonucleic acid (DNA) fragment sequenced by the nucleic acid sequencing device. A read sequence includes data that corresponds to a series of these nucleotide base calls as well as data describing quality scores for the series of nucleotides. This data is usually output from the sequencing device as a plurality of records (‘sequence’ or ‘sequencing’ data) for analysis/processing, for instance processing to correlate component parts, such as nucleotides, with respective positions in another sequence in a process referred to as alignment. Other processes such as variant calling, annotation, variant analysis, and reporting are common in bioinformatics processing. This processing typically relies on hardware-accelerated compute resources such as field-programmable gate arrays (FPGAs) to process the massive amounts of data generated from sequencing runs and downstream processing.

When cloud resource demands approach the limits of what is available in the datacenter, Service Level Agreements (SLAs) deteriorate, which causes bioinformatics pipelines to fail. For instance, one experiment launched parallel bioinformatics processing of involving parallel processing of possibly tens or hundreds of gigabases. This revealed significant cloud resource constraints and random errors. At its heaviest, one pipeline consumed multiple FPGA compute resources for >24 hours, 64 terabytes (TB) of file system storage, >100 TB of scratch storage (e.g., temporary storage, local to the compute resources). The pipeline included thousands of steps with runtimes that could range anywhere from a few seconds to multiple days each. Each step had less than 1% chance of failure, but the cumulative failure was enough to result in a 50% rate of failure, and the demand for compute instances and storage was many folds what some AZs were able to provide. Some AZs had just 2-5 FPGAs, others had no hardware-accelerated processing resources, and some had only 1 petabyte (PB) of file system storage.

Since the resources are shared among all cloud tenants and there is practically no way to control allocation to other tenants, it is desired to design a pipeline engine that orchestrates step execution in a way that is resilient to cumulative random failure of massive resource requests, long run times, and frequent timeouts waiting for specific resources.

Conventional engines are incapable of dealing with capacity issues at this scale. Common scaling modules fail silently at best or catastrophically at worst when capacity issues are encountered. This highlights the issue that is unique to the large resource demand typical of bioinformatics processing workloads. For the common tenant, the cloud is practically infinite and capacity issues are nonexistent, but this is not the case with cloud-based bioinformatics processing.

Aspects described herein provide a capacity-aware pipeline engine that can load balance across AZs and resources depending on saturation. For instance, an approach for bioinformatics pipeline implementation is proposed that is resilient to both the high rate of random error at scale and the volatility of cost and capacity from one AZ to another or from one time period (e.g., day) to the next. An example pipeline engine encompasses capacity discovery, and step deployment and execution orchestration in a pipeline structure that is idempotent and provides integrity at the lowest costs.

In one aspect, the engine is aware of the backlog of resource availability, which is a function of the requests for bioinformatics processing in the pipeline implemented in a cloud computing environment that are ready to be processed but cannot yet be processed due to resource or other constraints.

The bioinformatics processing for each request will include a set of step(s) for deployment and execution in the pipeline. Different requests might have the same or different requested steps, and will generally involve different data that is the subject of the requested processing. The engine may be aware of the backlog for each resource required for each step of each request, and across different available AZs. Thus, for a given request for bioinformatics processing in the pipeline, the engine may be aware of the backlog for each resource that is to be used to execute each step of the request. The engine could launch/deploy each step where there is smallest backlog.

The steps orchestrated by the engine can be designed to be idempotent and sized large enough that each step does not incur significant overhead costs with scale-up and scheduling, but small enough relative to availability in the smallest AZ and to minimize the cost of retry. For instance, large, serial request or steps requiring a relatively large compute capacity may be difficult to place in many AZs. This encourages breaking the steps into small enough units that the overhead of scheduling the steps and scaling the nodes up and down is not worse than the losses incurred in the event of an error and necessary reinvocation.

In additional aspects, a multilayered caching approach is taken with shared storage being used as a shared workspace across all steps of the requested bioinformatics processing and scratch space to cache results, output, states, etc., of intermediate steps. Scratch space for caching and persistence of completed data to shared storage means that failure in one step does not fatally impact the output of the entire pipeline. Taken together, these qualities enable retry and fallback (sometimes written “fall-back” or “fall back”) to alternate resource types when orchestrating the deployment and execution of a request.

In another aspect, a definition is received in conjunction with a request for bioinformatics processing, where the definition indicates, directly or indirectly, options for respective resources of varying resource types to use in executing each step of the plurality of steps. The definition could be received as part of the request or separate from the request itself. The definition might provide a respective definition for each step of the requested processing or a definition with applicability to more than one step. Any given definition, say one specific to a given step, could provide a list of possible resources that can be used in pipeline processing for that step and/or indications of amounts, quantities, specifications, properties, expectations, or the like about resources to be used in pipeline processing for that step. Thus, in particular examples, the definition could provide as part of a manifest or other definition a list of minimum requirements, from a resource standpoint, for step processing, to identify possible resources, some of which could be alternatives to each other, to satisfy those requirements. Each step is expected to require various types of resources, for instance compute, storage, volatile memory (i.e., working or random access memory), and/or scratch storage, as examples. In some embodiments, volatile memory is provided along with, or as part of, the compute resource, for instance in situations where cloud computer ‘instances’ are provided that incorporate both processing and volatile memory resources.

In any given AZ, different resources might be available to adequately satisfy each resource type—for instance, there might be a collection of different compute resources to select from, each of which is appropriate to satisfy the compute resource needed to process the step. In this regard, it is not uncommon for cloud providers to provide different resources of the same resource type as available options. Typically different resources will each offer their own advantages over other resources. Different compute resources might be tailored to different applications, for example. They may possibly be priced differently from each other and/or may be provided with different SLA guarantees.

An entity providing a request might provide, via a definition, a listing or other information to identify the resources that may be acceptable options/alternatives to each other in terms of satisfying the needed resource to complete each step. For a given cloud provider offering 8 different compute resources for the compute resource type, a requesting entity might identify via the definition 3, for example, of those 8 compute resources as being alternatives to use in processing a given step of the request. The definition could therefore indicate the three compute resources, and optionally present them with an explicit or implicit indication of priority as between the three options, or could be interpreted to determine the three alternative compute resources and optionally an indication of priority as between them. In examples, the engine can regard that indication as being authoritative in terms of the engine's selection of the specific compute resource to use when deploying that step for execution. There might similarly be different options for resources of the storage and memory types, and therefore the definition can provide similar indications for these resource types.

In some examples, the engine can select and route the processing for a request to the AZ that is identified as having the most or soonest availability of the one or more needed resources to process step(s) of the request, and/or the AZ having the lowest cost. The selection approach employed can vary depending on whether the approach is optimized for speed and reliability or cost, as examples. The requesting entity-a customer, for instance-might wish to emphasize speed and reliability in processing the request, with the tradeoff being that it will come at a higher cost.

As explained in further detail herein, the engine renders the bioinformatics processing resilient to errors by way of retry and fallback approaches. A retry threshold is a threshold number of retries to attempt with a current resource or resource set before fallback to a different one or more resources. Thus, if processing fails when using a first resource of a given resource type, the processing using that resource may be retried. If a retry threshold is reached, the engine can fall back on an alternate resource specified in the definition. That alternative resource might have an associated retry threshold that is the same or different from the retry threshold of the initial resource. If the processing fails again, this further retry and fallback approach can proceed through other resources indicated in the definition. Different retry thresholds can be used for different steps, and for different resources and/or different resource types. Errors can sometimes be correlated or attributed to a specific one or more resources, which would inform not only a retry threshold to check, but also potentially which resource(s) should potentially be replaced with alternative resources indicated by the definition. A higher retry threshold may be set for compute resources than for storage resources, for instance, meaning that more errors and subsequent retry will be tolerated for compute resources than for storage resources before a fallback to a different compute (or storage) resource will be taken. Additionally or alternatively, a different retry threshold might be set for retrying one resource of a given resource type than the retry threshold set for retrying another resource of the given resource type. As yet another option, there may be a global retry threshold set for a step, which is a number of overall retries that may be taken for the step, regardless of the error, before falling back to a different one or more resources.

In one approach, a lowest-cost-first approach is taken in which, for a set of alternative resources indicated by the definition, the engine will select the resource that is lowest cost to use at the time the step is to be deployed for execution. If processing fails with that selected resource and the retry threshold is met (i.e., zero or more retries with that resource are attempted up to the retry threshold), then the engine can fall back to the next-lowest cost resource of the set of alternative resources. In a different approach, reliability is favored and the engine can select the resource, of the set, that has the lowest probability of interruption. Any combination of these or other selection approaches can be used. For instance, a function could be constructed based on cost, interruption probably, and optionally other factors to determine the priority/order in which the resources will be selected and used to process the step to completion. Notably, a user, such as a tenant that builds the pipeline and/or requests for processing thereof, can tune parameters to control the selection approach(es) used by the engine, and these can vary at the request level, tenant level, or any other level of granularity in selecting an AZ to place the requested processing.

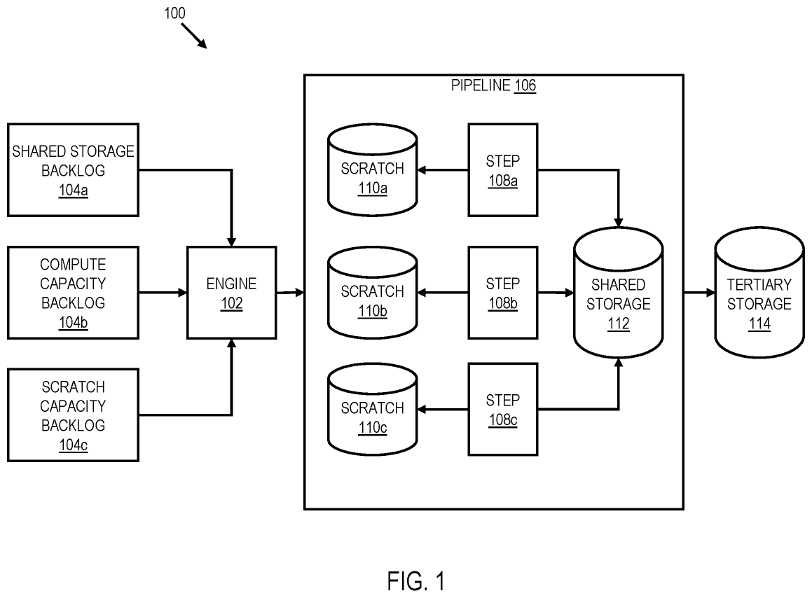

FIG. 1 depicts an example conceptual diagram of a processing pipeline and associated components within a cloud computing environment. The environment 100 includes an engine 102 executing on a computer system (not pictured) that takes backlogs 104a, 104b, 104c for different resources and orchestrates deployment and execution of requested bioinformatics processing steps in a pipeline 106. The pipeline processing in this example encompasses steps 108a, 108b, and 108c, though in some examples there could be tens, hundreds, thousands, or more steps. Example resource types to be used for the processing are shared storage, compute capacity, and scratch storage. Step 108a is to use scratch storage 110a, step 108b is to use scratch storage 110b, and step 108c is to use scratch storage 110c. Each step 108a, 108b, and 108c is to write data out to shared storage 112. Results may be further written out of the pipeline process to tertiary storage 114. Compute resources are not separately depicted in this example, but each of steps 108a, 108b, and 108c is processed by a respective compute resource. There are three resource types in this example, and therefore the engine intakes backlogs for each of the three types. Here, the engine intakes shared storage backlog 104a, compute capacity backlog 104b, and scratch capacity backlog 104c.

The pipeline 106 might be used for bioinformatics processing across a collection of requests. It is not uncommon in bioinformatics processing for the collection of requests to total petabytes of data, require tens or hundreds of compute resources, and require terabytes of scratch storage, cumulative across the steps of the requests and the requests of the collection. Furthermore, it is not uncommon for requests to be made in parallel, i.e., for an entity to request tens, hundreds, or thousands of requests to execute concurrently or within a given time period, say one day, week, or month. In these situations, the number of steps times the number of pipelines, which might potentially be invoked to execute in parallel or at least partially contemporaneously, can be massive.

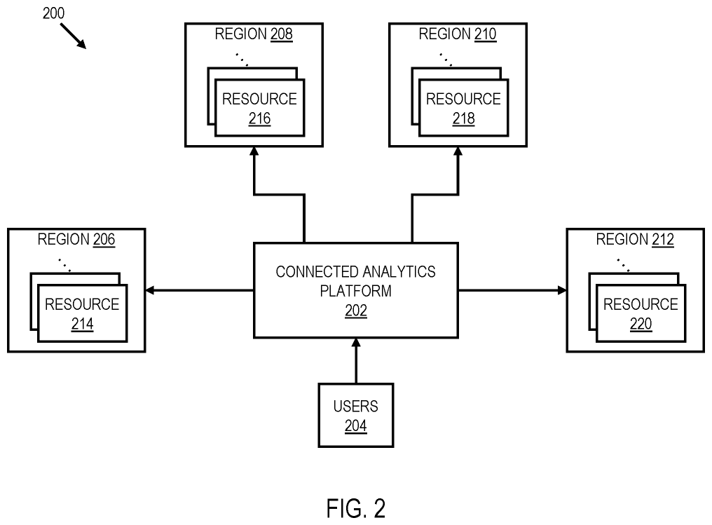

FIG. 2 depicts an example of a connected analytics environment 200 employing multiple cloud compute regions. A connected analytics platform 202 receives requests for analytics processing from users 204. The analytics requested may be, for instance, analytics in the form of bioinformatics processing in a bioinformatics pipeline. The platform 202 can also receive definitions in conjunction with those requests, as explained in further detail herein, and orchestrate the deployment and execution of the steps of the requested analytics in the bioinformatics pipeline implemented in the cloud environment in AZs thereof. Here, the AZs are provided in four possible regions 206, 208, 210, and 212. The regions 206, 208, 210, 212 include sets of resources 214, 216, 218 and 220, respectively. Each different region's set of resources can differ from the set of resources of the other regions, and so the resources and capacities thereof provided by each region may be unique to that region. Further, each region's set of resources can span different resource type(s) and, within each resource type, can include different resources of that type. Thus, the regions can differ in terms of the resources and capacities provided, including the types of resources provided.

As part of AZ selection for performing requested bioinformatics processing, compliance and cost requirements can factor into the decision-making process. For instance, there may be requirements or restrictions on transfer of data into and/or out of given regions. Data in a given region might be required to remain in that region, rather than being moved to another region for processing, for instance. Additionally, even if legal or other requirements do not prevent data from being moved to another region, the cost to do so might be so high that it is impractical to consider AZ(s) in that region.

Aspects discussed herein can help address and overcome the problem of capacity, spot, and random errors that may be experienced with current cloud computing environments in the context of bioinformatics processing.

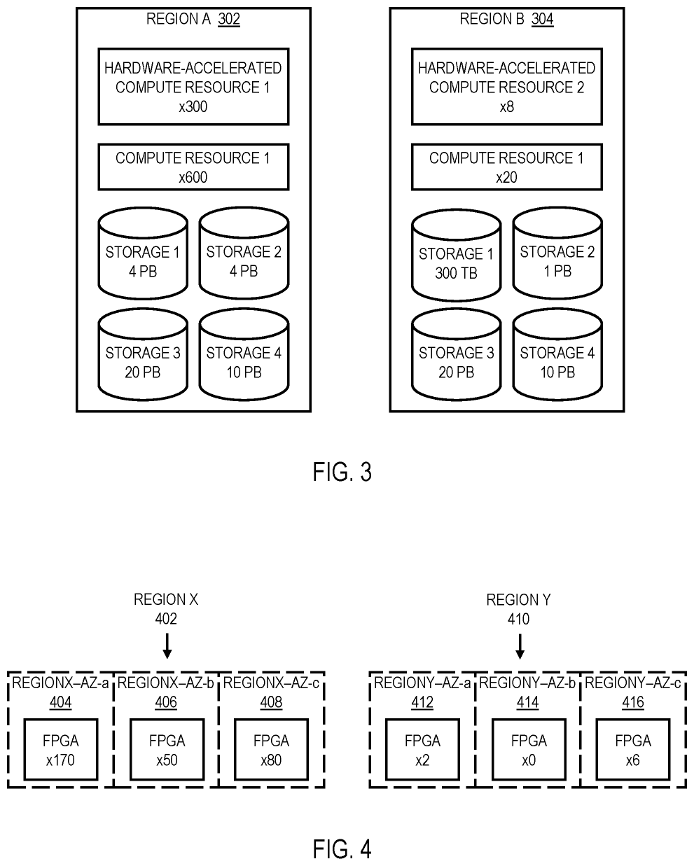

Capacity-related errors arise for various reasons. Once example is differences in regional capacity. FIG. 3 depicts an example of variation in regional capacity between two regions of a cloud environment. Region A 302 includes 300 units of hardware-accelerated compute resource 1, 600 units of standard compute resource 1, 4 PB of storage resource 1, 4 PB of storage resource 2, 20 PB of storage resource 3, and 10 PB of storage resource 4. Region B 304 includes 8 units of hardware-accelerated compute resource 2, 20 units of standard compute resource 1, 300 TB of storage resource 1, 1 PB of storage resource 2, 20 PB of storage resource 3, and 10 PB of storage resource 4.

By way of specific example, hardware-accelerated compute resource 1 is DRAGEN® Bio-IT FPGA offered by Illumina Inc., San Diego, USA (of which DRAGEN is a registered trademark), hardware-accelerated compute resource 2 is the f1.4×large FPGA instance offered by Amazon Web Services, Inc. (AWS) (a subsidiary of Amazon.com, Inc, Seattle, Washington, USA), standard compute resource 1 is the AWS Graviton processor offered by AWS based on the ARM architecture offered by ARM Holdings plc (Cambridge, England, United Kingdom), storage resource 1 is the Lustre file system offered by AWS, storage resource 2 is the Zettabyte File System (often referred to simply as ZFS), storage resource 3 is the EBS GP3 volume offered by AWS, and storage resource 4 is the EBS GP2 volume offered by AWS.

In the above example, which may be representative of a practical, real-world situation, it is seen that at the regional level there is a two-magnitude difference in terms of what is available for hardware-accelerated processing (FPGA) between the two regions, and significant differences in terms of standard compute resource 1 and storage resources 1 and 2. As a result, requested processing that might be handled fairly easily and without error by Region A might fail catastrophically if deployed to Region B.

There could also be drastic differences in the resources allotted to different availability zones. FIG. 4 depicts an example of variation in capacity between different availability zones across two regions of a cloud environment. Region X 402 includes AZs 404, 406, and 408 with 170, 50, and 80 units of FPGA compute resource, respectively. Region Y 410 includes AZs 412, 414, and 416 with 2, 0, and 6 units of FPGA compute resource, respectively. Deploying to AZ 412 a request to execute using 2 units of a hardware-accelerated processing resource might result in near immediate failure every time, while deploying the same request to AZ 404 might result in successful execution every time.

In addition to the above, there are often other tenants—perhaps many—with whom the cloud-provided resources are shared. Consequently, at any point in time another one or more tenants might consume any amount of provided resources. In some situations, a single tenant might consume the entire capacity of one or more resources of an entire AZ or region for days or weeks at a time, which will result in capacity error(s) for any other request for those resource(s). This can pose significant problems when desiring to process large-scale requests. By way of example, a technology producing hundreds of bioinformatics workflows for whole genome sequencing required 60 FPGA instances, 3200 Graviton instances, 3.2 PB od FSx storage, and 6.4 PB of GP3 volume for three days.

Some cloud computing requests target spare capacity at relatively low costs but with the tradeoff that the resources could be pulled back at any time. These so-called ‘spot’ arrangements can therefore result in ‘spot’ errors when resources are pulled from an executing step. Spot errors can be very costly, as pipeline prices can swing drastically, sometimes by 50%, in a very short amount of time such as an hour. This potentially results in a higher overall cost than if reserved resources were requested in the first place. The engine can be made resilient, as described herein, to both the price spikes and spot interruptions as well.

Random errors may also be experienced. In general, the probably of a random error in executing a step increases with higher resource utilization (e.g., 80% vs 99%) but even at peak usage may be relatively low, for instance only 0.05% in some cases. However, this probably is compounded for the number of steps of a request, and so even at a 99.95% success rate per step, a request with 1400 steps has a predicted success rate from start to finish of only (99.95)\hat{ }1400≈50%.

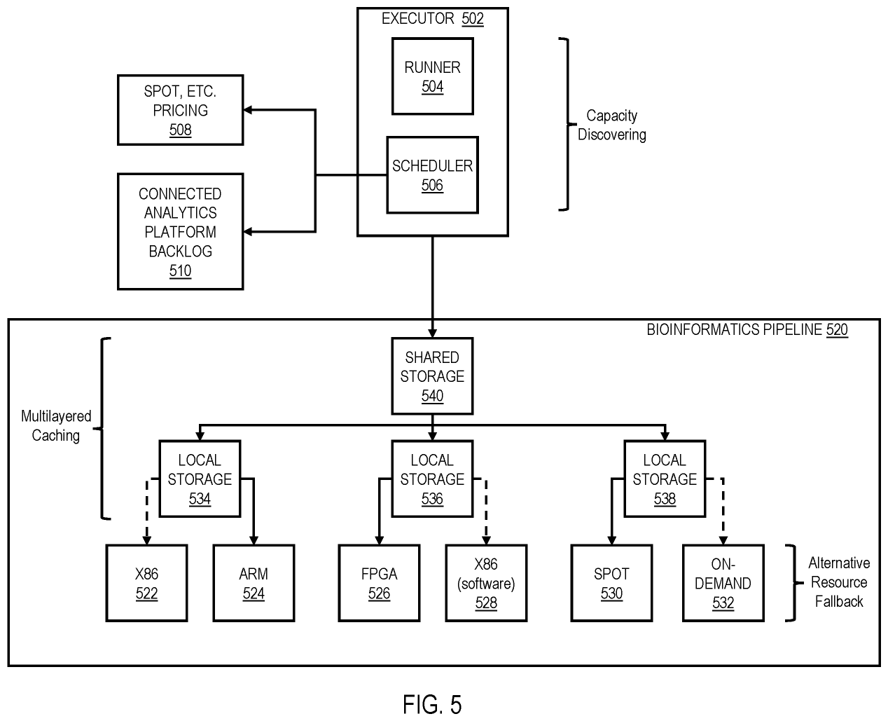

FIG. 5 depicts an example conceptual diagram of an atomic pipeline engine in accordance with aspects described herein. The engine includes an executor 502 responsible for orchestration of the deployment and execution of request steps-controlling the procession of the bioinformatics pipeline and making decisions about retries and fallbacks pursuant to the definition. A runner component 504 of the executor 502 handles task/step submission and retry, and monitors their execution by polling them after launch to monitor for successful/unsuccessful execution. A scheduler component 506 of the executor 502 handles scheduling based on pricing, interruption, and backlog metrics. For instance, the scheduler 506 receives spot pricing information 508 and receives and/or maintains a resource availability backlog 510 of the connected analytics platform, and in this manner is aware of the pricing and backlog information to help inform scheduling decisions. In some examples, the scheduler and runner execute on the same platform(s) that execute compute jobs (e.g., steps of the requested bioinformatics processing). Example such platform(s) are cluster(s) for container orchestration/execution. By way of specific example, there may be a static portion of a cluster that remains running for these, and dynamic portions of the cluster may be scaled up and down by the scheduler for the duration of tasks (e.g., steps of the requested bioinformatics processing).

The engine deploys request steps into the bioinformatics pipeline 520. The pipeline 520 is made resilient in part based on multilayer caching so that errors in steps do not affect the overall processes of the pipeline. Alternative resource fallbacks are also provided. Here, an alterative resource to x86 (offered by Intel Corporation, Santa Clara, California, USA) 522 is ARM 524, and an alternative resource of hardware-accelerated FPGA 526 is software executed on x86-based hardware 528. In addition, spot resources 530 and on-demand resources 532 are provided as alternatives to each other in this example, and in this regard alternatives in the arrangement (e.g., spot, on-demand, etc.) under which resources are provided may be indicated. The multilayer caching is implemented by local storage 534, 536, 538 associated with different pairs of resources in this example and an overall shared storage 540. Different resources can utilize their associated local storage for data exchange, and the local storages can exchange data with shared storage. By having multiple layers with shared and local storage, processing can be retried and/or fall back to alternate resources if capacity errors or other errors are encountered. Though not depicted in FIG. 5, local storages 534, 536, 538 and/or shared storage 540 can also have alternatives/fallback resource indicated (e.g., Lustre, ZFS, etc.).

As noted, varying approaches for scheduling may be taken. Hardware-accelerated processing using hardware FPGAs may be more prone to capacity/availability constraints but process a given task generally faster and with lower cost than software-based substitutes, which may have a higher cost and process slower but may be more abundant in terms of capacity/availability. If aggressive cost savings is preferred, then scheduling on more constrained resources with longer run times and possibly higher error and retry rates may be an acceptable approach.

Bioinformatics processing is a unique use case of cloud computing that suffers at scale more than other applications. From a data locality standpoint, replicating massive compute workloads globally is a challenge due to discrepancies in resource allocations across AZs and/or regions. From a cost standpoint, aggressive cost optimization can drive up error rates, but the risk may be worth it. From a capacity awareness standpoint, under typical scenarios the cloud platform is not maintained by the connected analytics platform and therefore both cloud capacity and exactly how much load the cloud platform is currently handling at any given time are unknown. Moreover, capacity, random, and spot errors for intensive compute processes are too expensive to reproduce and therefore it is too difficult to develop around these errors. Accordingly, the approach presented herein seeks to make bioinformatics processing in public cloud environments resilient to such errors.

The following presents example equations that may be used by an engine in its approach(es) to scheduling bioinformatics processing.

$${P}_{OverallFailure} = {\sum }_{Component Failure} {P}_{ComponentFailure} \qquad Eq . 1$$

The above represents the probability of an overall failure of a request as the sum of the probabilities of individual component failure, each component being a cloud resource involved in processing step(s) of the request, taken across the components involved in the processing.

As explained previously, a reasonable SLA failure rate in the cloud may be 0.05% but at scale across multiple steps and pushing nodes to their limits drastically increases the overall failure rate when the number of steps involves becomes appreciably high. A workflow with 500 steps has a (0.9995)\hat{ }500≈78% success rate and a workflow with 1000 steps has a (0.9995)\hat{ }1000≈61% success rate.

$$Eq . 2$$

$${Backlog}_{Resource} = max ( Ages of All Pending Steps Using Resource in AZ )$$

Equation 2 defines the backlog of a given resource to be the oldest age out of all of the to-be-deployed steps that use that resource. If there are 20 steps queued to use the resource and the oldest of those steps has been queued for 4 hours, the backlog of that resource may be taken to be 4 hours.

$$Eq . 3$$

$${Backlog}_{Overall} = max ( {Backlog}_{Disk} , {Backlog}_{Compute} , {Backlog}_{SharedStorage , …} )$$

Equation 3 defines the overall backlog of a given step to be the longest backlog of the resource(s) to be used to process that step.

$$Eq . 4$$

$${Cost}_{Total} = {\sum }_{Component} {Cost}_{Component} + {\sum }_{Retry} {Cost}_{Retry} + {\sum }_{Overhead} {Cost}_{Overhead}$$

Equation 4 provides one representation of total cost for processing a given request, which is equal to the sum of the costs of the components to use to process the request, added to the sum of the retry costs for the step retries to complete the request, added to the sum of the overhead costs involved in scheduling and retrying the steps of the request. As discussed previously, step atomicity can be made small enough so that errors can be absorbed with step retries, but not so small that the cost of retry and overhead involved in scheduling them is larger than the cost to have submitted larger steps to the pipeline in the first place.

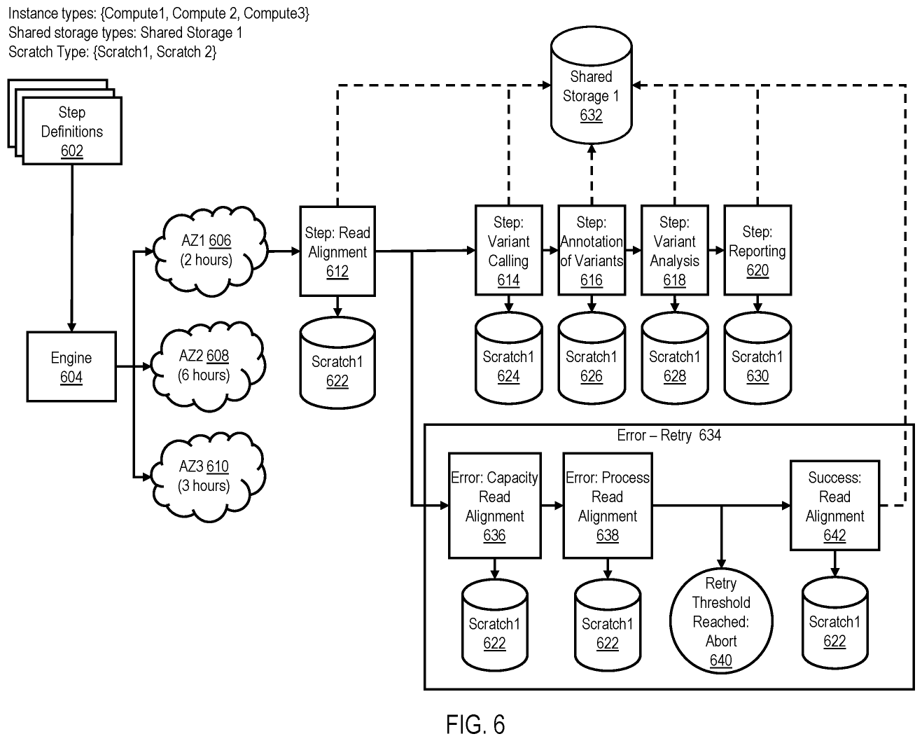

FIG. 6 depicts an example orchestration of bioinformatics processing steps in accordance with aspects described herein. Provided to the atomic pipeline engine 604 in conjunction with a request for bioinformatics processing is a definition 602 indicating options for resources of varying types to use in executing steps of the requested bioinformatics processing. In this example, the definition is provided as a plurality of individual step definitions. Each step might use or require different resources in comparison the resources/types for other steps of the request, though in this example the definition is consistent across each of the steps. Specifically, the definition 602 in this example indicates three resource types: (i) compute instances (which encompasses processing resource and, in some examples, volatile memory as well), (ii) shared storage, and (iii) scratch storage. For the first resource type, the definition indicates Compute 1, Compute 2, and Compute 3 as alternative compute resources that could be used as the needed compute resource type. For the second resource type-shared storage-only the single resource Shared Storage 1 is indicated, meaning only that type of shared storage is to be used in processing the steps of this requested processing. Lastly, the definition indicates Scratch 1 and Scratch 2 as alternatives for the third resource type, scratch storage. The definition can explicitly or implicitly set forth a priority or weight that the resources of each resource type are to be given. For instance, the Compute 1 compute resource listed first of the three alternative compute resources listed can be taken as an indication that Compute 1 is to be prioritized or preferred for use over Compute 2 and Compute 3.

Though not shown, the engine 604 can receive multiple requests with other steps and handle the orchestration thereof in the varying AZs 606, 608, 610. The engine 604 is thereby made aware of respective resources to use in executing the other steps of those requests. The engine can also orchestrate the deployment and execution of the other steps of those requests, which includes monitoring the queuing, deployment, and execution thereof. Though this monitoring, the engine can determine a resource availability backlog. The resource availability backlog indicates backlogs for varying resources of different resource types. It can therefore be used to predict a delay in commencing execution of any given processing step for each AZ of the monitored AZs based on the particular resource(s) to be used to process the step.

In the context of the request discussed above, and on the basis of selecting resources Compute 1, Storage 1, and Scratch 1 from the definition, the engine 604 identifies based on the backlog that backlog varies across the AZs: 2 hours for AZ1, 6 hours for AZ2, and 3 hours for AZ3. In other words, over time, the engine 604 has observed that the time taken for similar requests (in terms of resources used) to be deployed suggests that it will be 2 hours, 3 hours, or 6 hours to commence execution of this request if deployed to AZ1, AZ3, or AZ2, respectively.

In this example, the engine 604 routes the request to AZ1 on the basis that the backlog is smallest for that AZ. The request in this example includes five steps to be executed in series. In other examples, requests may include steps that may be executed concurrently, or some steps that can be executed concurrently and others that must be executed in-series.

The first step 612 in this example is sequence read alignment that uses Scratch 1 (622) for local temporary storage, Compute 1 (on which step 612 executes) for compute, and Shared Storage 1 (632) for data storage. If execution of step 612 is successful, output may be persisted from scratch space 622 to shared storage 632. Processing proceeds to the second step 614 for variant calling, which uses the same resources in this example. This continues as long as each successive step (616, 618, 620 for variant annotation, variant analysis, and reporting, respectfully) is successfully executed.

If instead an error resulted in executing step 612, this could initiate a retry and an alternate succession of processing depicted by 634. Here, as an example, a capacity error 636 in the execution of the read alignment step 612 results from attempting to scale-up. This error is identified, and execution of the step may be attempted one or more times using the same resource(s). On retry in this example, the capacity error does not appear but another error is raised-a process error 638. A retry threshold can be configured that limits how may retries, which could be 0 or more, will be attempted. If this threshold is reached, processing of this step, and optionally other step(s) of the request, could abort (640) and potentially fallback to other resource(s). If instead on a retry the execution of the step is successful (642), then the processing can persist the results to storage 632 and continue, for instance continue to step 614, the next step in this example.

As an alternative situation, and based on unsuccessful completion of step execution using a selected resource, this can prompt a fallback selection, using the definition, of a second resource (i.e., different resource) from the different resources indicated by the definition to use in executing the step. In examples, the fallback is performed after retrying using the current selected resource(s) the threshold number of times. The engine can reinitiate execution of the step with a direction to use that second resource. In addition, this could optionally select a different resource for each of one or more of the resource types used in executing that step. In other words, both a different compute resource and a different shared storage resource could be selected, if desired. This might be done in situations where different errors are encountered that suggest problems with different resources, as an example.

When retrying step execution and/or selecting a different resource, the engine might need to undertake various activities such as redeploying a step into the pipeline and/or initiating a data transfer between resources, as examples.

In an alternative scenario described with reference to FIG. 6, assume that the second and third steps can be executed concurrently. Completion of execution of step 612 therefore proceeds to concurrently execute both a second step 614 (and potentially one or more of subsequent steps 616, 618, 620) and a third step represented by processing 634 (for instance a realignment processing as one example). Assume further in this situation that the third step experiences error 636, retries and experiences error 638, and then is either aborted 640 or successfully completes 642. Just like the example above with a fully sequential pipeline, the third step here can succeed or fail, and be retried and/or redeployed to other resource(s) as described above, independent of the success or failure of the other steps.

In some examples, the fallback to an alternative resource or set of resources specified in the definition might be to resource(s) of a different AZ. In other words, the processing of one or more steps could be relocated to another AZ, possibly with relocation of the subsequent steps and/or transfer of necessary data of the processing to that point over to the different AZ, if necessary. This could be extended to additional AZs, in which a collection of three or more AZs are used as a result of fallbacks to alternative resources.

The scenario of FIG. 6 is used by way of example only; in practical applications, the aggregate number of steps may vary to total in the hundreds or thousands, resulting in resource demand of potentially tens of thousands of virtual central processing units, request runtimes stretching for days, parallelization on the order of hundreds, and storage requests on the order of petabytes per AZ. Magnified by potentially tens of thousands of requests for pipeline processing, often ran in daily or weekly bursts, an SLA of even 99% for some resources is expected to yield hundreds of errors/failures under conventional approaches. Proper orchestration of step execution and in an automated matter facilitated by an engine may be vital in these situations.

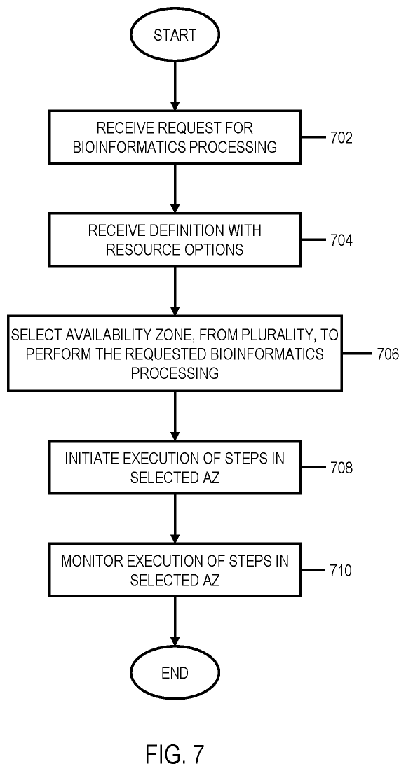

FIG. 7 depicts an example process for bioinformatics processing orchestration, in accordance with aspects described herein. In embodiments, the process is performed in whole or part by an engine as described herein executing on one or more computer systems, such as those of a cloud computing environment, for instance. Referring to FIG. 7, the process receives (702) a request for bioinformatics processing in a bioinformatics pipeline. The request is a digital construct defined, constructed, provided, and the like via computer system(s), possibly at the direction of a requesting user. The pipeline may be implemented in a cloud computing environment, for instance one with varying resources of different resource types and different monitored availability zones, each with respective resources. The bioinformatics processing includes a plurality of steps for deployment and execution in the bioinformatics pipeline. For instance, the plurality of steps can include, by way of example and not limitation, steps of genomic data processing, including read alignment, variant calling, variant annotation, and/or results analysis.

The process continues by receiving (704), in conjunction with the request, a definition indicating options for respective resources of varying resource types to use in executing each step of the plurality of steps. The definition is also a digital construct defined, constructed, provided, and the like via computer system(s), possibly at the direction of a requesting user. The definition can indicate the types of resources, and alternative resource(s) of those types, for use in executing the steps. A set of resources and resource types indicated could pertain to one, some, or all of the steps. Therefore, a definition could provide resources/types that pertain to different groups of one or more steps, or could provide a respective resources/type definition for each of the steps, as examples. The definition could be provided in one or more definition file(s).

The process continues by orchestrating the deployment and execution of the plurality of steps in the bioinformatics pipeline. Thus, the process proceeds by selecting (706), from the plurality of monitored AZs, an AZ to perform the requested bioinformatics processing, and initiating (708) execution of the plurality of steps in the selected AZ. In this regard, execution of the steps in/by the selected AZ could be initiated in any appropriate way, for instance by pushing or queueing the steps to the selected AZ to start executing. The received definition indicates the respective resources/types for use in processing each step of the steps. With respect to at least one of the steps and for a resource type to use in executing that step, the definition indicates a plurality of different resources, of that resource type, that are possible alternatives to each other for selection and use in executing the step. For instance, execution of the step might require a scratch storage type of resource and the definition could indicate multiple different resource offerings that could be used to satisfy that requirement. The different resources indicated for a given resource type could differ in their technical implementation. For instance, different compute resources of the compute resource type might encompass different instruction sets and/or hardware implementation.

Initiating execution (708) can therefore include using the definition to select a resource, from the indicated plurality of different resources, to use in executing the step and initiating execution of the step with a direction to the selected AZ to use that selected resource.

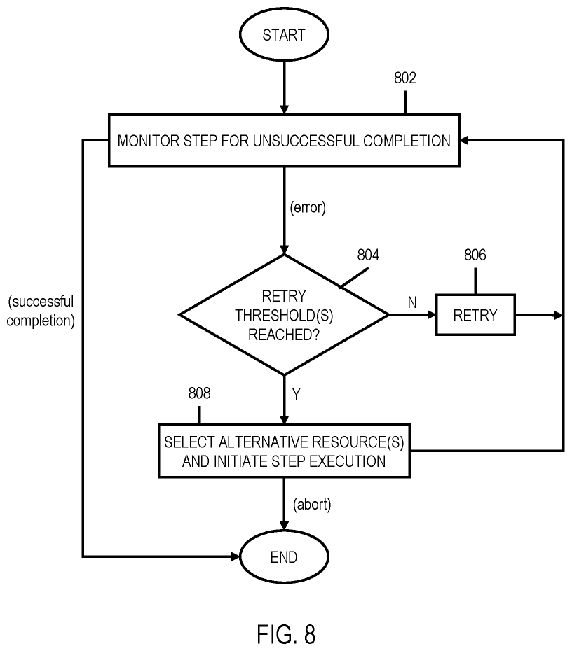

The process of FIG. 7 then monitors (710) execution of the plurality of steps in the selected AZ. The monitoring can, for instance, detect any backlog in processing the steps, as well as whether execution of the steps is successful or unsuccessful. An example process for this monitoring is described with reference to FIG. 8.

The process of FIG. 7 can be repeated across a collection of requests that request respective bioinformatics processing, which might include none, some, or all of the same steps as one or more other requests. Furthermore, each request will have an associated definition, which could be the same or different from definitions of other request(s). One distinguishing feature of the requests may be that the data provided as part of the requests for processing may vary across requests. For instance, the data for processing might be sequencing data for different sequences and the different requests might correlate to those different sequences to be processed.

FIG. 8 depicts an example process for monitoring execution of steps of requested bioinformatics processing, in accordance with aspects described herein. The process is presented with reference to a single step, but it should be understood that the monitoring could be performed for every step of each instance of requested bioinformatics processing.

Referring to FIG. 8, the process monitors (802) a step, which is being executed using a current set of resource(s) in the AZ, for an indication of unsuccessful completion of step execution, for instance an error in execution of the step. Example such errors in execution could include, but are not limited to, a resource capacity error, a random error, and/or a spot error. Other errors or events of unsuccessful execution completion are possible and the monitoring can identify those. If the step successfully completes execution, the process can receive an indication of successful completion and end.

If instead the monitoring 802 determines unsuccessful completion (e.g., an error), the process proceeds by determining (804) whether a retry threshold, as a threshold number of retries, has been reached. In one example, the relevant retry threshold to check is selected based on the particular error encountered. For instance, if the error pertains to a compute resource being used, the retry threshold could be one specific to that compute resource or to that type of resource, i.e., the ‘compute’ resource type. In other examples, the retry threshold is a global retry threshold for the step regardless which resources are involved. In yet other examples, the determination at 804 could check whether any one or more of a collection of retry thresholds have been reached. This may be useful in situations where there is a respective retry threshold for more than one resource of those being used when the error occurred and it is desired to check whether any of such thresholds have been reached.

Assuming the relevant threshold(s) have not been reached (804, N), the process increment(s) the relevant threshold(s), continues by retrying (806) execution of the step with the currently selected resource(s), and returns to continue monitoring (802) of the retried execution. In this manner, the processing could retry execution of the step one or more times using the current set of selected resource(s).

If it is instead determined at 804 that the retry threshold(s) have been reached (804, Y), then the process continues by selecting (808), using the definition, alternative resource(s), from the plurality of resources indicated by the definition, to use in executing the step, initiating execution of the step with direction to use those alternative resource(s), and continuing back to 802 to monitor this execution. The alternative resource(s) could be one or more resources. For instance, if the latest error is suggestive of error(s) with one or more specific resources of those that were currently selected to use in executing the step, then alternative(s) could be selected for any one or more of those for which there are alternatives indicated in the definition. The approach for selecting from the alternative resource(s) can follow any desired approach. In some examples, the selection selects alternative resource(s) that may or may not have been previously tried in other resource configurations. In a specific example, different combinations/permutations of resources that have not previously been tried for executing this step as part of the requested processing may be tried in selecting alternative resource(s) to use. In many examples, a single resource of a specific resource type is identified for replacing with an alternative resource, and the selecting (808) selects one of the alternatives to that resource from the set of alternative resources of that resource type.

If at 808 it is determined that alternative resource(s) selection is not available—for instance all alternative resources, as specified in the definition, for a problematic resource type have been tried without success, the process could abort step execution and end.

A desired outcome of the monitoring discussed with respect to FIG. 8 is that retries and/or fallback can be undertaken when necessary and with the appropriate adjustments in the resources, from the available resources, to use such that each step of the requested bioinformatics processing will successfully complete without having to relaunch the requested bioinformatics processing altogether.

In some situations, the AZ initially selected (FIG. 7, 706) is a first AZ and the alternative resource(s) selected at 808 to use in processing a step is/are provided by a second AZ of the plurality of monitored AZs. In that situation, initiating execution of the step with a direction to use the selected alternative resource(s) can initiate execution of the step in the second AZ with a direction to use the selected alternative resource(s) of the second AZ. It may be that in these situations other resources from the first AZ may no longer be needed or usable in conjunction with step execution or resource use in the second AZ. In some situations, the step may even need to be moved completely to the second AZ in terms of the location of all resources to use to execute that step.

The monitoring described herein enables a process to determine a resource availability backlog by monitoring deployment and execution of other steps of other requests for bioinformatics processing in the bioinformatics pipeline implemented by the cloud computing environment. This monitoring of the deployment and execution of the other steps is made aware of respective resources to use in executing the other steps, for instance because it is performed by an engine that handles orchestration of a collection of requests. Consequently, the resource availability backlog can indicate, for each AZ of the plurality of monitored AZs, a respective predicted delay in commencement of execution of the plurality of steps of a received request for bioinformatics processing. In other words, it can be predicted, for any given request and based on the resources indicated in the definition associated with the request, what the backlog/delay is anticipated to be for each AZ if the steps of the request were deployed to that AZ. The selection of the AZ to perform the requested bioinformatics processing can therefore select the AZ from the plurality of monitored AZs based at least in part on this resource availability backlog and what it indicates.

Additionally, a process can monitor spot pricing for resources in the plurality of monitored AZs and monitor execution interruption metrics (error rates, etc.) for the plurality of monitored AZs. The selection of the AZ (FIG. 7, 706) can select the AZ from the plurality of monitored AZs based at least in part, and in some examples in conjunction with the backlog, on at least one of the monitored spot pricing and the monitored execution interruption metrics. Thus, the backlog on each AZ may be just one consideration of multiple in the decision where to deploy the requested processing, and the selection approach can be constructed to account for each such consideration.

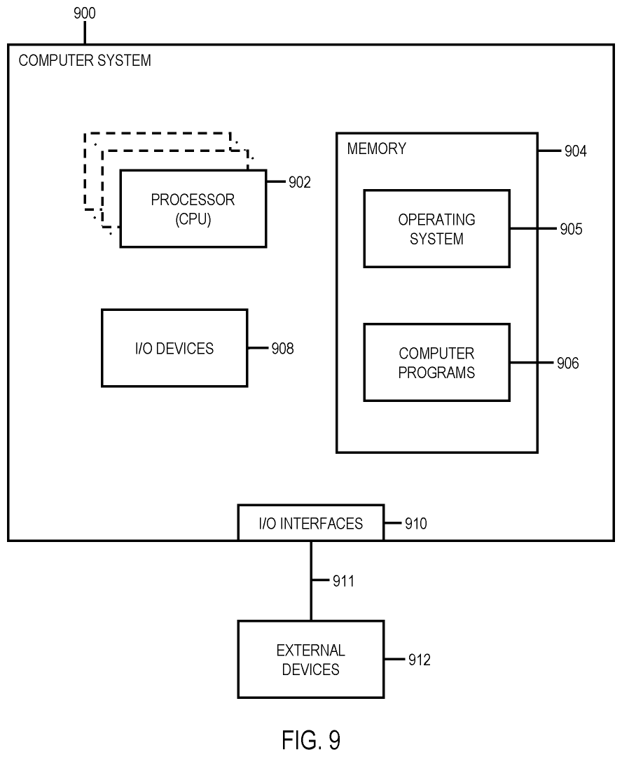

Processes described herein may be performed singly or collectively by one or more computer systems, such as one or more computer systems of, or in communication with, a genomic sequencing/sequencer device, or any other computer system(s), as examples. FIG. 9 depicts one example of such a computer system and associated devices to incorporate and/or use aspects described herein. A computer system may also be referred to herein as a data processing device/system, computing device/system/node, or simply a computer. The computer system may be based on one or more of various system architectures and/or instruction set architectures. Additionally, the computer system could be, or could be implemented in or by, one or more systems of cloud computing environment.

FIG. 9 shows a computer system 900 in communication with external device(s) 912. Computer system 900 includes one or more processor(s) 902, for instance central processing unit(s) (CPUs). A processor can include functional components used in the execution of instructions, such as functional components to fetch program instructions from locations such as cache or main memory, decode program instructions, and execute program instructions, access memory for instruction execution, and write results of the executed instructions. A processor 902 can also include register(s) to be used by one or more of the functional components. Computer system 900 also includes memory 904, input/output (I/O) devices 908, and I/O interfaces 910, which may be coupled to processor(s) 902 and each other via one or more buses and/or other connections. Bus connections represent one or more of any of several types of bus structures, including a memory bus or memory controller, a peripheral bus, an accelerated graphics port, and a processor or local bus using any of a variety of bus architectures. By way of example, and not limitation, such architectures include the Industry Standard Architecture (ISA), the Micro Channel Architecture (MCA), the Enhanced ISA (EISA), the Video Electronics Standards Association (VESA) local bus, and the Peripheral Component Interconnect (PCI).

Memory 904 can be or include main or system memory (e.g. Random Access Memory) used in the execution of program instructions, storage device(s) such as hard drive(s), flash media, or optical media as examples, and/or cache memory, as examples. Memory 904 can include, for instance, a cache, such as a shared cache, which may be coupled to local caches (examples include L1 cache, L2 cache, etc.) of processor(s) 902. Additionally, memory 904 may be or include at least one computer program product having a set (e.g., at least one) of program modules, instructions, code or the like that is/are configured to carry out functions of embodiments described herein when executed by one or more processors.

Memory 904 can store an operating system 905 and other computer programs 906, such as one or more computer programs/applications that execute to perform aspects described herein. Specifically, programs/applications can include computer readable program instructions that may be configured to carry out functions of embodiments of aspects described herein.

Examples of I/O devices 908 include but are not limited to microphones, speakers, Global Positioning System (GPS) devices, cameras, lights, accelerometers, gyroscopes, magnetometers, sensor devices configured to sense light, proximity, heart rate, body and/or ambient temperature, blood pressure, and/or skin resistance, and activity monitors. An I/O device may be incorporated into the computer system as shown, though in some embodiments an I/O device may be regarded as an external device (912) coupled to the computer system through one or more I/O interfaces 910.

Computer system 900 may communicate with one or more external devices 912 via one or more I/O interfaces 910. Example external devices include a keyboard, a pointing device, a display, a sequencing instrument, and/or any other devices that enable a user to interact with computer system 900. Other example external devices include any device that enables computer system 900 to communicate with one or more other computing systems or peripheral devices such as a printer. A network interface/adapter is an example I/O interface that enables computer system 900 to communicate with one or more networks, such as a local area network (LAN), a general wide area network (WAN), and/or a public network (e.g., the Internet), providing communication with other computing devices or systems, storage devices, or the like. Ethernet-based (such as Wi-Fi) interfaces and Bluetooth® adapters are just examples of the currently available types of network adapters used in computer systems (BLUETOOTH is a registered trademark of Bluetooth SIG, Inc., Kirkland, Washington, U.S.A.).

The communication between I/O interfaces 910 and external devices 912 can occur across wired and/or wireless communications link(s) 911, such as Ethernet-based wired or wireless connections. Example wireless connections include cellular, Wi-Fi, Bluetooth®, proximity-based, near-field, or other types of wireless connections. More generally, communications link(s) 911 may be any appropriate wireless and/or wired communication link(s) for communicating data.

Particular external device(s) 912 may include one or more data storage devices, which may store one or more programs, one or more computer readable program instructions, and/or data, etc. Computer system 900 may include and/or be coupled to and in communication with (e.g. as an external device of the computer system) removable/non-removable, volatile/non-volatile computer system storage media. For example, it may include and/or be coupled to a non-removable, non-volatile magnetic media (typically called a “hard drive”), a magnetic disk drive for reading from and writing to a removable, non-volatile magnetic disk (e.g., a “floppy disk”), and/or an optical disk drive for reading from or writing to a removable, non-volatile optical disk, such as a CD-ROM, DVD-ROM or other optical media.

Computer system 900 may be operational with numerous other general purpose or special purpose computing system environments or configurations. Computer system 900 may take any of various forms, well-known examples of which include, but are not limited to, personal computer (PC) system(s), server computer system(s), such as messaging server(s), thin client(s), thick client(s), workstation(s), laptop(s), handheld device(s), mobile device(s)/computer(s) such as smartphone(s), tablet(s), and wearable device(s), multiprocessor system(s), microprocessor-based system(s), telephony device(s), network appliance(s) (such as edge appliance(s)), virtualization device(s), storage controller(s), set top box(es), programmable consumer electronic(s), network PC(s), minicomputer system(s), mainframe computer system(s), and distributed cloud computing environment(s) that include any of the above systems or devices, and the like.

Aspects of the present invention may be a system, a method, and/or a computer program product, any of which may be configured to perform or facilitate aspects described herein.

In some embodiments, aspects may take the form of a computer program product, which may be embodied as computer readable medium(s). A computer readable medium may be a tangible storage device/medium having computer readable program code/instructions stored thereon. Example computer readable medium(s) include, but are not limited to, electronic, magnetic, optical, or semiconductor storage devices or systems, or any combination of the foregoing. Example embodiments of a computer readable medium include a hard drive or other mass-storage device, an electrical connection having wires, random access memory (RAM), read-only memory (ROM), erasable-programmable read-only memory such as EPROM or flash memory, an optical fiber, a portable computer disk/diskette, such as a compact disc read-only memory (CD-ROM) or Digital Versatile Disc (DVD), an optical storage device, a magnetic storage device, or any combination of the foregoing. The computer readable medium may be readable by a processor, processing unit, or the like, to obtain data (e.g. instructions) from the medium for execution. In a particular example, a computer program product is or includes one or more computer readable media that includes/stores computer readable program code to provide and facilitate one or more aspects described herein.

As noted, program instruction contained or stored in/on a computer readable medium can be obtained and executed by any of various suitable components such as a processor of a computer system to cause the computer system to behave and function in a particular manner. Such program instructions for carrying out operations to perform, achieve, or facilitate aspects described herein may be written in, or compiled from code written in, any desired programming language. In some embodiments, such programming language includes object-oriented and/or procedural programming languages such as C, C++, C#, Java, etc.

Program code can include one or more program instructions obtained for execution by one or more processors. Computer program instructions may be provided to one or more processors of, e.g., one or more computer systems, to produce a machine, such that the program instructions, when executed by the one or more processors, perform, achieve, or facilitate aspects of the present invention, such as actions or functions described in flowcharts and/or block diagrams described herein. Thus, each block, or combinations of blocks, of the flowchart illustrations and/or block diagrams depicted and described herein can be implemented, in some embodiments, by computer program instructions.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method comprising:
receiving a request for bioinformatics processing in a bioinformatics pipeline implemented in a cloud computing environment, the cloud computing environment comprising a plurality of monitored availability zones (AZs), each with respective resources, and the bioinformatics processing comprising a plurality of steps for deployment and execution in the bioinformatics pipeline;
receiving, in conjunction with the request, a definition indicating options for respective resources of varying resource types to use in executing each step of the plurality of steps; and
orchestrating the deployment and execution of the plurality of steps in the bioinformatics pipeline, the orchestrating comprising:
selecting, from the plurality of monitored AZs, an availability zone (AZ) to perform the requested bioinformatics processing;
initiating execution of the plurality of steps in the selected AZ, wherein the definition indicates, for a step of the plurality of steps and for a resource type to use in executing the step, a plurality of different resources, of that resource type, that are possible alternatives to each other for selection and use in executing the step, and wherein the initiating execution comprises:
using the definition to select a resource, from the indicated plurality of different resources, to use in executing the step; and
initiating execution of the step with a direction to the selected AZ to use the selected resource; and
monitoring the execution of the plurality of steps in the selected AZ.

2. The method of claim 1, wherein the selected resource is a first resource of the plurality of different resources, and wherein the method further comprises:
based on unsuccessful completion of execution of the step using the selected first resource, selecting, using the definition, a second resource, from the plurality of different resources to use in executing the step, the second resource being different from the first resource; and
initiating execution of the step with a direction to use the selected second resource.

3. The method of claim 2, further comprising:
identifying an error in the execution of the step using the selected first resource; and
retrying execution of the step one or more times using the selected first resource, wherein the selecting the second resource and the initiating execution of the step with the direction to use the selected second resource is performed based on reaching a retry threshold without successfully completing execution of the step.

4. The method of claim 2, wherein the error in execution comprises a resource capacity error, a random error, or a spot error.

5. The method of claim 2, wherein the selected AZ is a first AZ, wherein the second resource is provided by a second AZ of the plurality of monitored AZs, and wherein the initiating execution of the step with a direction to use the selected second resource initiates execution of the step in the second AZ with a direction to use the selected second resource of the second AZ.

6. The method of claim 1, further comprising determining a resource availability backlog by monitoring deployment and execution of other steps of other requests for bioinformatics processing in the bioinformatics pipeline implemented by the cloud computing environment, wherein the monitoring the deployment and execution of the other steps is made aware of respective resources to use in executing the other steps, wherein the resource availability backlog indicates a respective predicted delay in commencement of execution of the plurality of steps of the requested bioinformatics processing for each AZ of the plurality of monitored AZs, and wherein the selecting the AZ to perform the requested bioinformatics processing selects the AZ from the plurality of monitored AZs based at least in part on the resource availability backlog.

7. The method of claim 6, further comprising monitoring spot pricing for resources in the plurality of monitored AZs and monitoring execution interruption metrics for the plurality of monitored AZs, wherein the selecting the AZ selects the AZ from the plurality of monitored AZs based further in part on at least one of the monitored spot pricing and the monitored execution interruption metrics.

8. The method of claim 1, wherein the plurality of steps comprises steps of genomic data processing, including at least one of read alignment, variant calling, variant annotations, or results analysis.

9. A computer system comprising:
a memory; and
a processing circuit in communication with the memory, wherein the computer system is configured to perform a method comprising:
receiving a request for bioinformatics processing in a bioinformatics pipeline implemented in a cloud computing environment, the cloud computing environment comprising a plurality of monitored availability zones (AZs), each with respective resources, and the bioinformatics processing comprising a plurality of steps for deployment and execution in the bioinformatics pipeline;
receiving, in conjunction with the request, a definition indicating options for respective resources of varying resource types to use in executing each step of the plurality of steps; and
orchestrating the deployment and execution of the plurality of steps in the bioinformatics pipeline, the orchestrating comprising:
selecting, from the plurality of monitored AZs, an availability zone (AZ) to perform the requested bioinformatics processing;
initiating execution of the plurality of steps in the selected AZ, wherein the definition indicates, for a step of the plurality of steps and for a resource type to use in executing the step, a plurality of different resources, of that resource type, that are possible alternatives to each other for selection and use in executing the step, and wherein the initiating execution comprises:
using the definition to select a resource, from the indicated plurality of different resources, to use in executing the step; and
initiating execution of the step with a direction to the selected AZ to use the selected resource; and
monitoring the execution of the plurality of steps in the selected AZ.

10. The computer system of claim 9, wherein the selected resource is a first resource of the plurality of different resources, and wherein the method further comprises:
based on unsuccessful completion of execution of the step using the selected first resource, selecting, using the definition, a second resource, from the plurality of different resources, to use in executing the step, the second resource being different from the first resource; and
initiating execution of the step with a direction to use the selected second resource.

11. The computer system of claim 10, wherein the method further comprises:
identifying an error in the execution of the step using the selected first resource; and
retrying execution of the step one or more times using the selected first resource, wherein the selecting the second resource and the initiating execution of the step with the direction to use the selected second resource is performed based on reaching a retry threshold without successfully completing execution of the step.

12. The computer system of claim 10, wherein the error in execution comprises a resource capacity error, a random error, or a spot error.

13. The computer system of claim 10, wherein the selected AZ is a first AZ, wherein the second resource is provided by a second AZ of the plurality of monitored AZs, and wherein the initiating execution of the step with a direction to use the selected second resource initiates execution of the step in the second AZ with a direction to use the selected second resource of the second AZ.

14. The computer system of claim 9, wherein the method further comprises determining a resource availability backlog by monitoring deployment and execution of other steps of other requests for bioinformatics processing in the bioinformatics pipeline implemented by the cloud computing environment, wherein the monitoring the deployment and execution of the other steps is made aware of respective resources to use in executing the other steps, wherein the resource availability backlog indicates a respective predicted delay in commencement of execution of the plurality of steps of the requested bioinformatics processing for each AZ of the plurality of monitored AZs, and wherein the selecting the AZ to perform the requested bioinformatics processing selects the AZ from the plurality of monitored AZs based at least in part on the resource availability backlog.

15. The computer system of claim 14, wherein the method further comprises monitoring spot pricing for resources in the plurality of monitored AZs and monitoring execution interruption metrics for the plurality of monitored AZs, wherein the selecting the AZ selects the AZ from the plurality of monitored AZs based further in part on at least one of the monitored spot pricing and the monitored execution interruption metrics.

16. The computer system of claim 9, wherein the plurality of steps comprises steps of genomic data processing, including one or more of: read alignment, variant calling, variant annotations, and results analysis.

17. A computer program product comprising:
a computer readable storage medium readable by a processing circuit and storing instructions for execution by the processing circuit to:
receiving a request for bioinformatics processing in a bioinformatics pipeline implemented in a cloud computing environment, the cloud computing environment comprising a plurality of monitored availability zones (AZs), each with respective resources, and the bioinformatics processing comprising a plurality of steps for deployment and execution in the bioinformatics pipeline;
receiving, in conjunction with the request, a definition indicating options for respective resources of varying resource types to use in executing each step of the plurality of steps; and
orchestrating the deployment and execution of the plurality of steps in the bioinformatics pipeline, the orchestrating comprising:
selecting, from the plurality of monitored AZs, an availability zone (AZ) to perform the requested bioinformatics processing;
initiating execution of the plurality of steps in the selected AZ, wherein the definition indicates, for a step of the plurality of steps and for a resource type to use in executing the step, a plurality of different resources, of that resource type, that are possible alternatives to each other for selection and use in executing the step, and wherein the initiating execution comprises:
using the definition to select a resource, from the indicated plurality of different resources, to use in executing the step; and
initiating execution of the step with a direction to the selected AZ to use the selected resource; and
monitoring the execution of the plurality of steps in the selected AZ.

18. The computer program product of claim 17, wherein the selected resource is a first resource of the plurality of different resources, and wherein the method further comprises:
based on unsuccessful completion of execution of the step using the selected first resource, selecting, using the definition, a second resource, from the plurality of different resources, to use in executing the step, the second resource being different from the first resource; and
initiating execution of the step with a direction to use the selected second resource.

19. The computer program product of claim 18, wherein the method further comprises:
identifying an error in the execution of the step using the selected first resource; and
retrying execution of the step one or more times using the selected first resource, wherein the selecting the second resource and the initiating execution of the step with the direction to use the selected second resource is performed based on reaching a retry threshold without successfully completing execution of the step.

20. The computer program product of claim 18, wherein the error in execution comprises a resource capacity error, a random error, or a spot error.

21. The computer program product of claim 18, wherein the selected AZ is a first AZ, wherein the second resource is provided by a second AZ of the plurality of monitored AZs, and wherein the initiating execution of the step with a direction to use the selected second resource initiates execution of the step in the second AZ with a direction to use the selected second resource of the second AZ.

22. The computer program product of claim 17, wherein the method further comprises determining a resource availability backlog by monitoring deployment and execution of other steps of other requests for bioinformatics processing in the bioinformatics pipeline implemented by the cloud computing environment, wherein the monitoring the deployment and execution of the other steps is made aware of respective resources to use in executing the other steps, wherein the resource availability backlog indicates a respective predicted delay in commencement of execution of the plurality of steps of the requested bioinformatics processing for each AZ of the plurality of monitored AZs, and wherein the selecting the AZ to perform the requested bioinformatics processing selects the AZ from the plurality of monitored AZs based at least in part on the resource availability backlog.

23. The computer program product of claim 22, wherein the method further comprises monitoring spot pricing for resources in the plurality of monitored AZs and monitoring execution interruption metrics for the plurality of monitored AZs, wherein the selecting the AZ selects the AZ from the plurality of monitored AZs based further in part on at least one of the monitored spot pricing and the monitored execution interruption metrics.

24. The computer program product of claim 17, wherein the plurality of steps comprises steps of genomic data processing, including one or more of: read alignment, variant calling, variant annotations, and results analysis.
